(19) United States
(12) Patent Application Publication
(10) Pub. No.: US 2012/0316862 A1
(43) Pub. Date: Dec. 13, 2012

(54) AUGMENTING STATISTICAL MACHINE TRANSLATION WITH LINGUISTIC KNOWLEDGE

(75) Inventors: Soha Mohsen Hassan Sultan, Mountain View, CA (US); Keith Hall, Brooklyn, NY (US)

(73) Assignee: GOOGLE INC., Mountain View, CA (US)

(21) Appl. No.: 13/493,475

(22) Filed: Jun. 11, 2012

Related U.S. Application Data
(60) Provisional application No. 61/495,928, filed on Jun. 10, 2011.

(51) Int. Cl. G06F 17/28

(52) U.S. Cl. 704/4

(57) ABSTRACT

A computer-implemented technique can include receiving, at a computing system including one or more processors, a translation model including a plurality of aligned pairs of phrases in first and second languages. The technique can include determining, at the computing system, one or more features for each of the plurality of pairs of phrases based on linguistic differences between the first and second languages to obtain a plurality of sets of features. The technique can include associating, at the computing system, the plurality of sets of features with the plurality of pairs of phrases, respectively, to obtain a modified translation model. The technique can also include performing, at the computing system, statistical machine translation from the first language to the second language using the modified translation model.

### CROSS-REFERENCE TO RELATED APPLICATIONS

This application claims the benefit of U.S. Provisional Application No. 61/495,928, filed on Jun. 10, 2011. The entire disclosure of the above application is incorporated herein by reference.

### BACKGROUND

This section provides background information related to the present disclosure which is not necessarily prior art.

Statistical machine translation (SMT) generally utilizes statistical models to provide a translation from a source language to a target language. One type of SMT is phrase-based statistical machine translation. Phrase-based SMT can map sets of words (phrases) from a source language to a target language. Phrase-based SMT may rely on lexical information, e.g., the surface form of the words. The source language and the target language, however, may have significant lexical differences, such as when one of the languages is morphologically-rich.

### SUMMARY

A computer-implemented technique is presented. The technique can include receiving, at a computing system including one or more processors, a translation model including a plurality of pairs of phrases, each of the plurality of pairs of phrases including a first phrase of one or more words in a first language and a second phrase of one or more words in a second language, wherein a specific first phrase is aligned with a specific second phrase for a specific pair of phrases. The technique can include determining, at the computing system, one or more features for each of the plurality of pairs of phrases based on linguistic differences between the first and second languages to obtain a plurality of sets of features. The technique can include associating, at the computing system, the plurality of sets of features with the plurality of pairs of phrases, respectively, to obtain a modified translation model. The technique can also include performing, at the computing system, statistical machine translation from the first language to the second language using the modified translation model.

In some embodiments, the modified translation model has lexical and inflectional agreement for each of the plurality of pairs of phrases.

In other embodiments, one of the first and second languages is a morphologically-rich language.

In some embodiments, the morphologically-rich language is characterized by morphological processes that produce a large number of word forms for a given root word.

In other embodiments, the morphologically-rich language is a synthetic language.

In some embodiments, one of the first and second languages is a non-morphologically-rich language.

In other embodiments, the non-morphologically-rich language is an isolating language or an analytic language.

In some embodiments, the one or more features include at least one of parts of speech features and dependency features.

In other embodiments, the parts of speech features include at least one of personal pronouns, possessive pronouns, determiners, particles, and wh-nouns.

In some embodiments, the dependency features include syntactic divergences including at least one of word order, verb-less phrases, and possessiveness.

In other embodiments, the dependency features include lexical divergences including at least one of idiomatic expressions, prepositions, named entities, ambiguity, and alignment difficulties.

In some embodiments, performing the statistical machine translation using the modified translation model further includes: receiving, at the computing system, one or more words in the first language; generating, at the computing system, one or more potential translations of the one or more words using the modified translation model, the one or more potential translations having one or more probability scores, respectively; selecting, at the computing system, one of the one or more potential translations based on the one or more probability scores to obtain a selected translation; and outputting, at the computing system, the selected translation.

Another computer-implemented technique is also presented. The technique can include receiving, at a computing system including one or more processors, a translation model configured for translation between a first language and a second language. The technique can include receiving, at the computing system, a plurality of pairs of phrases, each of the plurality of pairs of phrases including a first phrase of one or more words in the first language and a second phrase of one or more words in the second language, wherein a specific first phrase is aligned with a specific second phrase for a specific pair of phrases. The technique can include receiving, at the computing system, a source phrase for translation from the first language to the second language. The technique can include determining, at the computing system, a translated phrase based on the source phrase using the translation model. The technique can include determining, at the computing system, a selected second phrase from the plurality of pairs of phrases based on the translated phrase. The technique can include predicting, at the computing system, one or more features for each word of the translated phrase based on the selected second phrase, a selected first phrase associated with the selected second phrase, and linguistic differences between the first and second languages. The technique can include modifying, at the computing system, the translated phrase based on the one or more features to obtain a modified translated phrase. The technique can also include outputting, from the computing system, the modified translated phrase.

In some embodiments, the translated phrase has lexical and inflectional agreement with the source phrase.

In other embodiments, the one or more features include at least one of lemma, parts of speech features, morphological features, and dependency features.

In some embodiments, predicting the one or more features for each word in the translated phrase further includes determining, at the computing system, at least one of the lemma, the part of speech features, and the morphological features for each word in the selected first phrase and for each word in the selected second phrase.

In other embodiments, predicting the one or more features for each word in the translated phrase further includes projecting, at the computing system, dependency relations from the selected first phrase to the selected second phrase based on an alignment between the selected first phrase and the selected second phrase and the part of speech features of both the selected first phrase and the selected second phrase.

In some embodiments, the parts of speech features include at least one of personal pronouns, possessive pronouns, determiners, particles, and wh-nouns.

In other embodiments, the dependency features include syntactic divergences including at least one of word order, verb-less phrases, and possessiveness.

In some embodiments, the dependency features include lexical divergences including at least one of idiomatic expressions, prepositions, named entities, ambiguity, and alignment difficulties.

In other embodiments, one of the first and second languages is a morphologically-rich language.

In some embodiments, the morphologically-rich language is characterized by morphological processes that produce a large number of word forms for a given root word.

In other embodiments, the morphologically-rich language is a synthetic language.

In some embodiments, one of the first and second languages is a non-morphologically-rich language.

In other embodiments, the non-morphologically-rich language is an isolating language or an analytic language.

A system is also presented. The system can include one or more computing devices configured to perform operations. The operations can include receiving a translation model including a plurality of pairs of phrases, each of the plurality of pairs of phrases including a first phrase of one or more words in a first language and a second phrase of one or more words in a second language, wherein a specific first phrase is aligned with a specific second phrase for a specific pair of phrases. The operations can include determining one or more features for each of the plurality of pairs of phrases based on linguistic differences between the first and second languages to obtain a plurality of sets of features. The operations can include associating the plurality of sets of features with the plurality of pairs of phrases, respectively, to obtain a modified translation model. The operations can also include performing statistical machine translation from the first language to the second language using the modified translation model.

In some embodiments, the modified translation model has lexical and inflectional agreement for each of the plurality of pairs of phrases.

In other embodiments, one of the first and second languages is a morphologically-rich language.

In some embodiments, the morphologically-rich language is characterized by morphological processes that produce a large number of word forms for a given root word.

In other embodiments, the morphologically-rich language is a synthetic language.

In some embodiments, one of the first and second languages is a non-morphologically-rich language.

In other embodiments, the non-morphologically-rich language is an isolating language or an analytic language.

In some embodiments, the one or more features include at least one of parts of speech features and dependency features.

In other embodiments, the parts of speech features include at least one of personal pronouns, possessive pronouns, determiners, particles, and wh-nouns.

In some embodiments, the dependency features include syntactic divergences including at least one of word order, verb-less phrases, and possessiveness.

In other embodiments, the dependency features include lexical divergences including at least one of idiomatic expressions, prepositions, named entities, ambiguity, and alignment difficulties.

In some embodiments, the operation of performing the statistical machine translation using the modified translation model further includes: receiving one or more words in the first language; generating one or more potential translations of the one or more words using the modified translation model, the one or more potential translations having one or more probability scores, respectively; selecting one of the one or more potential translations based on the one or more probability scores to obtain a selected translation; and outputting the selected translation.

Another system is also presented. The system can include one or more computing devices configured to perform operations. The operations can include receiving a translation model configured for translation between a first language and a second language. The operations can include receiving a plurality of pairs of phrases, each of the plurality of pairs of phrases including a first phrase of one or more words in the first language and a second phrase of one or more words in the second language, wherein a specific first phrase is aligned with a specific second phrase for a specific pair of phrases. The operations can include receiving a source phrase for translation from the first language to the second language. The operations can include determining a translated phrase based on the source phrase using the translation model. The operations can include determining a selected second phrase from the plurality of pairs of phrases based on the translated phrase. The operations can include predicting one or more features for each word of the translated phrase based on the selected second phrase, a selected first phrase associated with the selected second phrase, and linguistic differences between the first and second languages. The operations can include modifying the translated phrase based on the one or more features to obtain a modified translated phrase. The operations can also include outputting the modified translated phrase.

In some embodiments, the translated phrase has lexical and inflectional agreement with the source phrase.

In other embodiments, the one or more features include at least one of lemma, parts of speech features, morphological features, and dependency features.

In some embodiments, the operation of predicting the one or more features for each word in the translated phrase further includes determining at least one of the lemma, the part of speech features, and the morphological features for each word in the selected first phrase and for each word in the selected second phrase.

In other embodiments, the operation of predicting the one or more features for each word in the translated phrase further includes projecting dependency relations from the selected first phrase to the selected second phrase based on an alignment between the selected first phrase and the selected second phrase and the part of speech features of both the selected first phrase and the selected second phrase.

In some embodiments, the parts of speech features include at least one of personal pronouns, possessive pronouns, determiners, particles, and wh-nouns.

In other embodiments, the dependency features include syntactic divergences including at least one of word order, verb-less phrases, and possessiveness.

In some embodiments, the dependency features include lexical divergences including at least one of idiomatic expressions, prepositions, named entities, ambiguity, and alignment difficulties.

In other embodiments, one of the first and second languages is a morphologically-rich language.

In some, embodiments, the morphologically-rich language is characterized by morphological processes that produce a large number of word forms for a given root word.

In other embodiments, the morphologically-rich language is a synthetic language.

In some embodiments, one of the first and second languages is a non-morphologically-rich language.

In other embodiments, the non-morphologically-rich language is an isolating language or an analytic language.

The details of one or more embodiments of the subject matter described in this specification are set forth in the accompanying drawings and the description below. Other features, aspects, and advantages of the subject matter will become apparent from the description, the drawings, and the claims.

### DRAWINGS

The drawings described herein are for illustrative purposes only of selected embodiments and not all possible implementations, and are not intended to limit the scope of the present disclosure.

FIG. 1 is a tree illustrating example relationships between various Arabic pronouns;

FIG. 2A illustrates an example of correct and incorrect translations of an attached Arabic preposition;

FIG. 2B illustrates an example of correct and incorrect translations of separate Arabic prepositions;

FIG. 3 illustrates an example system for executing techniques according to some implementations of the present disclosure;

FIG. 4 illustrates an example dependency tree projection according to some implementations of the present disclosure;

FIG. 5A illustrates an example of extracting an Arabic predicate-subject relation from an English syntactic dependency parse tree according to some implementations of the present disclosure;

FIG. 5B illustrates an example of extracting an Arabic relative words relation from an English syntactic dependency parse tree according to some implementations of the present disclosure;

FIG. 6 is a flow diagram of an example technique for generating a modified language model according to some implementations of the present disclosure; and

FIG. 7 is a flow diagram of an example technique for post-processing of a translated phrase according to some implementations of the present disclosure.

Corresponding reference numerals indicate corresponding parts throughout the several views of the drawings.

### DETAILED DESCRIPTION

Statistical Machine Translation (SMT) is a method for translating text from a source language to a target language. SMT, however, can provide inaccurate or imprecise translations when compared to high quality human translation, especially when one of the two languages is morphologically rich. A morphologically-rich language can be characterized by morphological processes that produce a large number of word forms for a given root word. For example, a morphologically-rich language may be a synthetic language. Alternatively, for example, a non-morphologically-rich language may be an isolating language or an analytic language. Also, the greater the lexical and syntactic divergences between the two languages, the more the need for incorporating linguistic information in the translation process increases.

Because Arabic is a polysynthetic language where every word has many attachments, segmentation of Arabic words is expected to improve translation from or to English. which is an isolating language (i.e., each unit of meaning is represented by a separate word). Segmentation also helps the sparsity problem of morphologically rich languages. Segmentation has considered Arabic-English translation because this direction does not require post-processing to connect the Arabic segments into whole words. Additionally, segmentation of Arabic can help achieve better translation quality.

Tokenization and normalization of Arabic data may be utilized to improve SMT. Post processing may be needed to reconnect the morphemes into valid Arabic words, e.g., to de-tokenize and de-normalize the previously tokenized and normalized surface forms. Training SMT models on Arabic lemmas instead of surface forms may increase translation quality.

To help with syntactic divergences, specifically word order, reordering of the source sentence as preprocessing can be used. Because word order in Arabic is different from English, reordering may help alignment as well as the order of words in the target sentence.

Another reordering approach focuses on verb-subject constructions for Arabic-to-English SMT. This approach may differentiate between main clauses and subordinate clauses and applied different rules for each case. Reordering based on automatic learning can have an advantage of being language independent. Some techniques try to decrease the divergences between the two languages through preprocessing and post-processing to make the two languages more similar. Other techniques incorporate linguistic information in the translation and language models. One technique uses lexical, shallow syntactic, syntactic and positional context features. Adding context features may help identify disambiguation as well as other specification problems such as choosing whether a noun should be accusative, dative or genitive in German. The features can be added to a log-linear translation model, Minimum Error Rate Training (MERT) can then be performed to estimate the mixture coefficients.

Source-side contextual features have been considered in which grammatical dependency relations are incorporated in Phrase-Based SMT (PB-SMT) as a number of features. Other efforts toward improving target phrase selection can include applying source-similarity features in PB-SMT. In some techniques, the source sentences are maintained along with the phrase pairs in the phrase table. In translating a source sentence, similarity between the source sentence and the sentences from which the phrase pair were extracted was considered as a feature in the log-linear translation model.

Language models that rely on morphological features in addition to lexical features were developed to overcome sparsity as well as inflectional agreement errors. The sparsity problem impacts SMT both in the bilingual translation model and in the used language model. Because Arabic is morphologically rich, e.g., most base words are inflected by adding affixes that indicate gender, case, tense, number, and other features, its vocabulary is very large. This can lead to incorrect language model probability estimation because of the sparsity and the high Out-of-Vocabulary (OOV) rate. A Joint morphological-lexical language model (JMLLM) can combine the lexical information with the information extracted from a morphological analyzer. Predicting the correct inflection of words in morphologically rich languages has been performed on Russian and Arabic SMT outputs including applying a Maximum Entropy Markov Model (k-MEMM). A Maximum Entropy Markov Model is a structured prediction model where the current prediction is conditioned on the previous k predictions.

Integrating other sources of linguistic information, such as morphological or syntactic information, in the translation process can provide improvements especially for translation between language pairs with large topological divergences. English-Arabic is an example of these language pairs. While Arabic-English translation is also difficult, it does not require the generation of rich morphology at the target side. Translation from English to Arabic is one focus of this specification; however, the used techniques are also useful for translation into other morphologically rich languages.

One goal of the techniques described in this specification is to solve some of the problems resulting from the large gap between English and Arabic. This specification introduces two techniques for improving English-Arabic translation through incorporating morphology and syntax in SMT. The first part applies changes to the statistical translation model while the second part is post-processing. In the first part, adding syntactic features to the phrase table is described. The syntactic features are based on the English syntactic information and include part-of-speech (POS) and dependency features. POS features are suggested to penalize phrases that include English words that do not correspond to Arabic words. These phrases are sources of error because they usually translate to Arabic words with different meaning or even with different POS tags. An example is a phrase containing the English word “the” which should map in Arabic to the noun prefix “Al” and never appear as a separate word. For example, in scenarios in which the used Arabic segmentation does not separate the “A1” from nouns, the choice of POS features can depend on the used Arabic segmentation.

The techniques described in this specification are motivated at least in part by the structural and morphological divergences between the two languages. Two reasons behind adding these syntactic features are the complex affixation to Arabic words as well as the lexical and inflectional agreement.

Dependency features are features that rely on the syntactic dependency parse tree of the sentences from which a certain phrase was extracted. These features are suggested because they can solve a number of error categories, the main two of which are lexical agreement and inflectional morphological agreement. An example of lexical agreement is phrasal verbs where a verb takes a specific preposition to convey a specific meaning. When the verb and the preposition are in separate phrases, they are less likely to translate correctly. However, selecting a phrase containing both words in the same phrase may increase the likelihood of their lexical agreement.

Inflectional agreement is a syntactic-morphological feature of the Arabic language. Some words should have morphological agreement with other words in the sentence, e.g., an adjective should morphologically agree with the noun it modifies in gender, number, etc. Morphological agreement also applies to other related words such as verbs and their subjects, words connected by conjunction and others. To increase the likelihood of correct inflectional agreement of two syntactically related words, a phrase containing both words should be selected by the decoder. This increases the likelihood of their agreement since phrases are extracted from morphologically correct training sentences. The weights of the added features are then evaluated automatically using the Minimum Error Rate Training (MERT) algorithm. The results show an improvement in the automatic evaluation score BLEU over the baseline system.

The second part of the specification introduces a post-processing framework for fixing inflectional agreement in MT output. In particular, the present specification focuses on specific constructions, e.g., morphological agreement between syntactically dependent words. The framework is also a probabilistic framework which models each syntactically extracted morphological agreement relation separately. Also, the framework predicts each feature such as gender, number, etc. separately instead of predicting the surface forms, which decreases the complexity of the system and allows training with smaller corpora. The predicted features along with the lemmas are then passed to the morphology generation module which generates the correct inflections.

In contrast to the first part of the specification which aims at improving morphology by adding features and thus modifying the main pipeline of SMT, the second part introduces a probabilistic framework for morphological generation incorporating syntactic, morphological and lexical information sources through post-processing. While dependency features also aim at solving inflectional agreement, it may have limitations that can be overcome by post-processing. First, dependency features are added for words which are at small distances in the sentence. This is because phrase based SMT systems may limit the length of phrases. Related words that have distances more than the maximum phrase length are not helped. Second, phrases that contain related words could be absent from the phrase table because they were not in the training data or were filtered because they were not frequent enough. Finally, other features that have more weight than dependency features could lead to selecting other phrases.

Using the decoder of the baseline system, the component that can motivate selecting the correctly inflected words is the N-gram language model. For example, 3- or 4-gram language models may be used, which means agreement between close words can be captured. The language model can fix the agreement issues where:
The correct inflected word form is present in the phrase table.
Inflected phrases having the same semantics are clustered and all other translation feature values are normalized.

If both conditions apply, the correct inflected form of a word can be generated if the agreement relation is with a close word. However, the above two conditions may be difficult to apply, for example, because of the following reasons:
Sparsity: The correct inflection of a word that agrees with the rest of the sentence might be absent from the phrase table because it was not in the training data or appeared very few times and subsequently got filtered.
The lack of robust Arabic analysis and disambiguation tools leads to erroneous clustering of words. Because the units in the phrase table are actually phrases and not words, clustering becomes more difficult and more ambiguous. Clustering errors may hurt the semantic quality of the SMT system and should be avoided.

Therefore, a different approach to solving agreement issues in SMT through post processing is described. The approach can avoid the above problems because it:
relies on syntactic dependencies to identify potential agreements and therefore can handle agreement between largely distant words.
generates inflected word forms that were never seen in the parallel training data, which helps in solving the sparsity problem.
works with the output of any machine translation system.
is language independent.

One embodiment of the described subject matter improves the inflectional agreement of the Arabic translation output as proven by the automatic and human evaluations.

### Log Linear Phrase-Based Statistical Machine Translation

A log linear statistical machine translation system can be used. The log linear approach to SMT uses the maximum-entropy framework to search for the best translation into a target language of a source language text given the following decision rule:

$${\hat{e}}_{1}^{I} = {arg max}_{{e}_{1}^{I}} {\sum }_{m = 1}^{M} {λ}_{m} {h}_{m} ( {e}_{1}^{I} , {f}_{1}^{J} ) \qquad ( 1 )$$

where e₁^{l}=e₁, e₂, e₃ . . . eₗ is the best translation for the input foreign language text string, e.g., sentence, f₁^{J}=f₁, f₂, f₃ . . . f_{J}, hₘ(e₁^{l},f₁^{J}) are the used feature functions including, for example, translation and language model probabilities. For example, the translated English output target language text string for an input source language test string in Arabic. The unknown parameters λ₁^{M} are the weights of the feature functions and are evaluated using development data as will be discussed below.

Training the translation model starts by aligning the words of the sentence pairs in the training data using, for example, one of the IBM translation models. To move from word-level translation systems to phrase-based systems which can capture context more powerfully, a phrase extraction algorithm can be used. Subsequently, feature functions could be defined at the phrase level.

Using a translation model which translates a source-language sentence f into a target-language sentence e through maximizing a linear combination of features and weights allows easily extending it by defining new feature functions.

### Alignment

For every sentence pair (e₁^{l},f₁^{J}), the Viterbi alignment is the alignment a₁^{J} such that:

$${a}_{1}^{J} = {arg max}_{{a}_{1}^{J}} Pr ( {f}_{1}^{J} , {a}_{1}^{J} \vert {e}_{1}^{I} ) \qquad ( 2 )$$

where aⱼ is the index of the word in e₁^{l} to which fⱼ is aligned.

Word alignments can be calculated using GIZA++, which uses the IBM models 1 to 5 and the Hidden Markov Model (HMM) alignment model, all of which do not permit a source word to align to multiple target words. GIZA++ allows many-to-many alignments by combining the Viterbi alignments of both directions: source-to-target and target-to-source using some heuristics.

### Phrase Table

After alignment and phrase extraction, the phrases and associated features are stored in a phrase table. Given an aligned phrase pair: source-language phrase f̅ and a corresponding target-language phrase ē, the most common phrase features are:
The phrase translation probability:

$$p ( \overline{e} \vert \overline{f} ) - \frac{count ( \overline{e} \vert \overline{f} )}{{\sum }_{\overline{e}} count ( \overline{e} \vert \overline{f} )} \qquad ( 3 )$$

The inverse phrase translation probability:

$$p ( \overline{f} \vert \overline{e} ) - \frac{count ( \overline{e} \vert \overline{f} )}{{\sum }_{\overline{f}} count ( \overline{e} \vert \overline{f} )} \qquad ( 4 )$$

Additional features can include syntactic information, context information, etc.

The log linear model is very easy to extend by adding new features. After adding new features, feature weights need to be calculated using MERT which is described below.

### System Training: MERT

For log linear SMT translation systems, the output translation is governed by equation 1. In such systems, the best translation is the one that maximizes the linear combination of weighted features. Equation 5 shows a model using the feature functions discussed above in addition to a feature function representing the language model probability.

$${\hat{e}}_{1}^{I} = {arg max}_{{e}_{1}^{I}} {λ}_{1} p ( {e}_{1}^{I} \vert {f}_{1}^{J} ) + {λ}_{2} p ( {f}_{1}^{J} \vert {e}_{1}^{I} ) + {λ}_{3} p ( {e}_{1}^{I} ) + … + {λ}_{M} {h}_{M} ( {e}_{1}^{I} , {f}_{1}^{J} ) \qquad ( 5 )$$

where the translation and inverse translation probabilities are calculated as the multiplication of the separate phrase probabilities shown in equations 3 and 4, respectively. The third feature function is the language model probability of the output sentence.

These weights λ₁^{M} can be calculated using, for example, gradient descent to maximize the likelihood of the data according to the following equation:

$${\hat{λ}}_{1}^{M} = {arg max}_{{λ}_{1}^{M}} {\sum }_{s = 1}^{S} p {λ}_{1}^{M} ( {e}_{s} \vert {f}_{s} ) \qquad ( 6 )$$

using a parallel training corpus consisting of S sentence pairs. This method corresponds to maximizing the likelihood of the training data, but it does not maximize translation quality for unseen data. Therefore, Minimum Error Rate Training (MERT) is used instead. A different objective function which takes into account translation quality by using automatic evaluation metrics such as BLEU score is used. MERT aims at optimizing the following equation, instead:

$${λ}_{1}^{M} = {arg max}_{{λ}_{1}^{M}} {\sum }_{s = 1}^{S} E ( {r}_{s} , \hat{e} ( {f}_{s} ; {λ}_{1}^{M} ) ) \qquad ( 2.7 )$$

where E(r, e) is the result of computing a score based on an automatic evaluation metric, e.g., BLEU and ê(fₛ;λ₁^{M}) is the best output translation according to equation 1.

### Arabic Morphology

Arabic morphology is complex if compared to English morphology. Similar to English, Arabic morphology has two functions: derivation and inflection, both of which are discussed above. On the other hand, there are two different types of morphology, i.e., two different ways of applying changes to the stem or the base word. These two types are the templatic morphology and the affixational morphology. The functions and types of morphology are discussed in this section. As will be shown, Arabic affixational morphology is the most complex and constitutes the majority of English-Arabic translation problems.

### Morphology Function

Derivational Morphology is about creating words from other words (root or stem) while the core meaning is changed. An example from English is creating “writer” from “write”. Similarly, generating [symbol] kAtb “writer” from [symbol] ktb “to write” is an example of derivational morphology in Arabic.

Inflectional Morphology is about creating words from other words (root or stem) while the core meaning remains unchanged. An example from English is inflecting the verb “write” to “writes” in the case of third person singular. Another example is generating the plural of a noun, e.g., “writers” from “writer”. An example in Arabic is generating [symbol] AlbnAt “the girls” from [symbol] Albnt “the girl”. Arabic inflectional morphology is much more complex than English inflectional morphology. English nouns are inflected for number (singular/plural) and verbs are inflected for number and tense (singular/plural, present/past/past-participle). English Adjectives are not inflected. On the contrary, Arabic nouns and adjectives are inflected for gender (feminine/masculine), number (singular/dual/plural), state (definite/indefinite). Arabic verbs are inflected also for gender and number besides tense (command/imperfective/perfective), voice (active/passive) and person (1/2/3).

### Morphology Type

Templatic Morphology

In Arabic, the root morpheme consists of three, four, or five consonants. Every root has an abstract meaning that's shared by all its derivatives. According to known templates, the root is modified by adding additional vowels and consonants in a specific order to certain positions to generate different words. For example, the word [symbol] kAtb “writer” is derived from the root [symbol] ktb “to write” by adding alef “A” between the first and second letters of the root.

Affixational Morphology

This morphological type is common in most languages. It is about creating a new word from other words (roots or stems) by adding affixes: prefixes and suffixes. Affixes added to Arabic base-words are either inflectional markings or attachable clitics. Assuming inflectional markings are included in the BASE WORD, attachable clitics in Arabic follows a strict order as in: [cnj+[prt+[art+BASE WORD+pro]]]

Prefixes include:
cnj: conjunctions such as w,f meaning and, then, respectively.
prt: some prepositions and particles such as b,l,k meaning by/with, to, as, respectively.
art: definite article Al meaning the.
inflectional markings for tense, gender, number, person, etc.
   Suffixes include:
pro personal pronouns for verbs and possessive pronouns for nouns.

By contrast, English affixational morphology is simpler because there is no clitics attached to the words. Affixational morphology in English is used for both inflection and derivation. Examples include:
Inflectional markings such as adding ed to the end of the verb to indicate past or past participle tense. Also, adding s to the end of the present form of a verb indicates it is singular. On the other hand, adding s to the end of a noun indicates that it's plural.
Derivational morphology, for example, adding er to read generates a different word which is reader. Examples of prefixes include “mis,” “in” and “un” for negation as in “misrepresent,” “incorrect” and “undeniable,” respectively.

English words do not have attachable clitics like Arabic. Examples I and II illustrate how one Arabic word can correspond to five and four English words respectively.

| | |
|---|---|
| (I) | [symbol] wsyEtyhA |

| | | | |
|---|---|---|---|
| w+ | s+ | yEty+ | hA |
| and | will | he gives | her |
| conj. | Prt | BASE WORD | prn |

‘and he will give her’

| (II) | [symbol] | | | |
|---|---|---|---|---|
| | wl>TfAlhm | | | |
| | w+ | l+ | >Tfal+ | hm |
| | and | for | children | their |
| | conj. | Prt | BASE WORD | prn |

‘and for their children’

As shown above, Arabic affixational and inflectional morphology are very complex especially compared to English. The complex morphology is the main reason behind the problems of sparsity, agreement, and lexical divergences as will be explained in more detail in this chapter.

### Arabic Inflectional Agreement

In Arabic, there are rules that govern the inflection of words according to their relations with other words in the sentence. These rules are referred to throughout the specification as “agreement rules.” Agreement rules can involve information such as the grammatical type of the words, e.g., Part-of-Speech (POS) tags, the relationship type between the words and other specific variables. In this section, a few undetailed agreement rules are explained as examples.

### Verb-Subject

Verbs should agree morphologically with their subjects. Verbs that follow the subject (in SVO order) agree with the subject in number and gender (see example III). On the other hand, verbs that precede the subject (VSO) agree with the subject in gender while having the singular 3rd person inflection (see example IV).

| | | |
|---|---|---|
| (III) | [symbol] | [symbol] |
| | *hbwA | AlrjAl |
| | left.masc.pl | men.masc.pl |

‘The men left’

| | | |
|---|---|---|
| (IV) | [symbol] | [symbol] |
| | AlrjAl | *hb |
| | men.masc.pl | left.masc.pl |

‘The men left’

### Noun-Adjective

Adjectives always follow their noun in determinism, gender and number. There are many other factors that add more rules, for example if the adjective is describing a human or an object, if the noun is plural but not in the regular plural form (e.g., broken plural), etc. Example V shows how the adjective “polite” follows the noun “sisters” in being definite, feminine and plural. This is an example where the noun refers to humans and is in the regular feminine plural form.

| | | |
|---|---|---|
| (V) | [symbol] | [symbol] |
| | Almh*bAt | Al>xwAt |
| | polite.def.fem.pl | sisters.def.fem.pl |

‘The polite sisters’

Example VI shows how the adjective polite follows the noun in being definite, masculine and plural. In this example, the noun is in the masculine broken plural form.

| | | |
|---|---|---|
| (VI) | [symbol] | [symbol] |
| | Almh*bwn | Al>xwp |
| | polite.def.masc.pl | brothers.def.masc.pl |

‘The polite brothers’

In example VII, the adjective follows the noun in definiteness; however, the adjective is feminine and singular, while the noun is masculine and plural. This is because the noun is a broken plural representing more than one object (e.g., books).

| | | |
|---|---|---|
| (VII) | [symbol] | [symbol] |
| | Alktb | Almfydp |
| | beneficial.def.fem.s | books.def.masc.pl |

‘The beneficial books’

### Number-Noun

If a noun is modified by a number, the noun is inflected differently according to the value of the number. For example, if the number is 1, the noun will be singular. If the number is 2, the noun should have dual inflection. For numbers (3-10), the noun should be plural. For numbers (>11), the noun should be singular.

### Conjunctions

Words that have conjunction relations always agree with each other.

### Other

There are other cases of agreement. For example, demonstrative and relative pronouns should agree with the nouns that they co-refer to.

### Sparsity

Sparsity is a result of Arabic complex inflectional morphology and the various attachable clitics. In some implementations, while the number of Arabic words in a parallel corpus is 20% less than English words, the number of unique Arabic words can be over 50% more than the number of unique English words.

Sparsity causes many errors in SMT output in a number of ways:
Absence of word forms: the correct inflection of a word that agrees with the rest of the sentence could be absent from the phrase table because it was not in the training data or was infrequent and therefore was filtered.
Poor Translation Probability Estimation: In SMT, translation probabilities are estimated through counting (refer to equation 3). Sparsity implies that words appear less frequently in the training data, which implies poor estimation of probabilities.
Poor Language Model Estimation: Sparsity also causes poor estimation of language model probabilities.

### Syntactic Divergences

Word Order

Subjects

The main sentence structure in Arabic is Verb-Subject-Object (VSO), while English sentence structure is Subject-Verb-Object (SVO). The order SVO also occurs in Arabic but is less frequent. Therefore subjects can be pre-verbal or post-verbal. Additionally, subjects can be pro-dropped, e.g., subject pronouns do not need to be expressed because they are inferable from the verb conjugation. Example VIII shows a case of a pro-dropped subject. The subject is a masculine third-person pronoun that is dropped because it can be inferred from the verb inflection.

| | | |
|---|---|---|
| (VIII) | [symbol] | [symbol] |
| | AltfAHp | >klt. |
| | the Apple | he ate |

‘He ate the apple.’

Adjectives

In Arabic, adjectives follow the nouns that they modify as opposed to English where the adjectives precede the nouns. Example IX shows the order of nouns and adjectives.

| | | |
|---|---|---|
| (IX) | [symbol] | [symbol] |
| | Al>myn | Alrjlthe |
| | honest | The man |

‘The honest man’

Verb-Less Sentences

In Arabic, verb-less sentences are nominal sentences which have no verbs. They usually exhibit the zero copula phenomenon, e.g., the noun and the predicate are joined without overt marking. These sentences are usually mapped to affirmative English sentences containing the copular verb to be in the present form. Example X shows an example of a nominal sentence.

| | | |
|---|---|---|
| (X) | [symbol] | [symbol] |
| | Aglw | rA}E. |
| | wonderful | The weather. |

‘The weather is wonderful’

One possible problem that can result from this syntactic divergence is when none of the three phrases “The weather is wonderful”, “The weather is”, or “is wonderful” exists in the phrase table, in which case “is” would be translated separately to an incorrect word. This results from the bad alignment of the word “is” to other Arabic words during training.

Possessiveness

The Arabic equivalent of possessiveness between nouns and of the of-relationship is called ldafa. The idafa construct is achieved by having the word indicating the possessed entity precede a definite form of the possessing entity. Refer to example XI for an illustration of this construct.

| | |
|---|---|
| (XI) | The child’s bag. |
| | The bag of the child. |

| | |
|---|---|
| [symbol] | [symbol] |
| Al.Tfl | Hkybp |
| The-child | bag |

Lexical Divergences

Lexical divergences are the differences between the two languages at the lexical level. They result in translation problems, some of which are discussed in this section.

Idiomatic Expressions

Expressions are usually incorrectly translated as they are translated as separate words. Mapping each word or a few words to their corresponding meaning in Arabic usually results in a meaningless translation or at least a translation with a meaning that does not correctly match the English expression. Examples XII and XIII illustrate the problem.

| | |
|---|---|
| (XII) | Source: “brand new” |

| | |
|---|---|
| Target: | |
| [symbol] | [symbol] |
| jdydp | mArkp |
| new | brand |

| | |
|---|---|
| | ‘new brand’ |
| (XIII) | Source: “go all out” meaning “do your best” |
| | Target: |

| | |
|---|---|
| [symbol] | [symbol] |
| $Amlp | Al*hAb |
| totally | going |

‘going totally’

Prepositions

Verbs that take prepositions cause problems in translation. Translating the verb alone to an Arabic verb and the preposition to a corresponding Arabic preposition usually results in errors. The same applies to prepositions needed by nouns. In example XIV, although “meeting” is translated correctly to its corresponding Arabic word, the direct translation of the preposition leads to a wrong phrase.

| | |
|---|---|
| (XIV) | Source: meeting on |

| | |
|---|---|
| Target: | |
| [symbol] | [symbol] |
| ElY | AjtmAE |
| on top of | meeting |

‘meeting on top of’

Named Entities

Named entities cause a problem in translation. Translating named entities word-by-word results in wrong Arabic output.

Ambiguity

Differences between the two languages sometimes cause translation ambiguity errors. For example the word “just” can translate in Arabic to [symbol] : EAdl: as in “a just judge”. It can also translate to [symbol] : fqt: meaning “only”. Therefore, sense disambiguation is required to achieve high quality translations.

Alignment Difficulties

Direct mapping of English words to Arabic words is not possible because of the lexical, morphological and grammatical differences. During alignment, this problem generates errors that are transferred to the phrase table. Some examples include:
Auxiliaries: In English, auxiliaries can be added, for example, to express certain tenses or to express the passive voice. This is not the case in Arabic where different tenses are represented by inflecting the verbs or by different diacritizations. This problem results in erroneous word mappings resulting from aligning an English sentence containing auxiliaries to an Arabic sentence. For example, sometimes “was” translates to “ [symbol] ”: fy: meaning “in”. Another example was found when “does” translates to “ [symbol] ”: IA: meaning “no”. These cases result in extra prepositions which results in meaningless or ungrammatical Arabic sentences.
Verb to be: Sentences with a present verb to be such as “The girl is nice” translates in Arabic to a nominal sentence (see above). If “is” is selected in a separate phrase, an extra incorrect word will be added to the sentence.
Particles also usually result in extra Arabic prepositions, nouns or verbs breaking the semantic and grammatical structure of the Arabic sentence.

Error Analysis Summary

Manual error analysis can be performed, in one example, on a small sample of 30 sentences which were translated using a state-of-the-art phrase-based translation system. Despite the small sample size, most errors described appeared in the output sentences. Morphological, syntactic and lexical divergences contributed to the errors. These divergences make the alignment of sentences from both languages very difficult and consequently result in problems in phrase extraction and mapping. Therefore, errors in the phrase table were very common.

Phrase table errors could directly lead to errors in the final translation output. They can result, for example, in missing or additional clitics in Arabic words and sometimes extra Arabic words. Besides, it is very common that English verbs map to Arabic nouns in the phrase table, which results in problems in the final grammatical structure of the output sentence. Ambiguity is also a phrase table problem. This is because the phrase table is based on the surface forms not taking context into consideration. Seventeen sentences out of the thirty had errors because of these phrase table problems.

Morphological agreement is a major problem in the Arabic output. The main problems are the agreement of the adjective with the noun and the agreement of the verb with the subject. Nine sentences had problems with adjective-noun agreement, while two had problems with verb-subject agreement.

Named Entities and acronyms which were translated directly resulted in errors in nine sentences.

### Adding Syntactic Phrase Constraints

POS Features

In general, most POS features are added to penalize the incorrectly mapped phrase pairs. The English part of these phrase pairs usually does not have a corresponding Arabic translation (see examples above). Therefore, it is usually paired with incorrect Arabic phrases. The POS features can be added to discourage these phrase pairs from being selected by the decoder. These features mark phrases that consist of one or more of personal and possessive pronouns, prepositions, determiners, particles and wh-words. Example POS features are summarized in Table A. After adding the features, MERT is used to calculate their weights.

TABLE A
Word classes for connectable phrases

| POS | Explanation |
|---|---|
| PRP | Personal Pronouns: subject pronouns and object pronouns |
| PRP$ | Possessive Pronouns |
| DT | Determiners: a, the, this, etc. |
| IN | Prepositions |
| RP | Particles |
| WDT | Wh-determiner: what, which |
| WP | Wh-pronoun: who, whether, which (head of a wh- noun phrase) |
| WRB | Possessive Wh-pronoun: whose |

Personal Pronouns

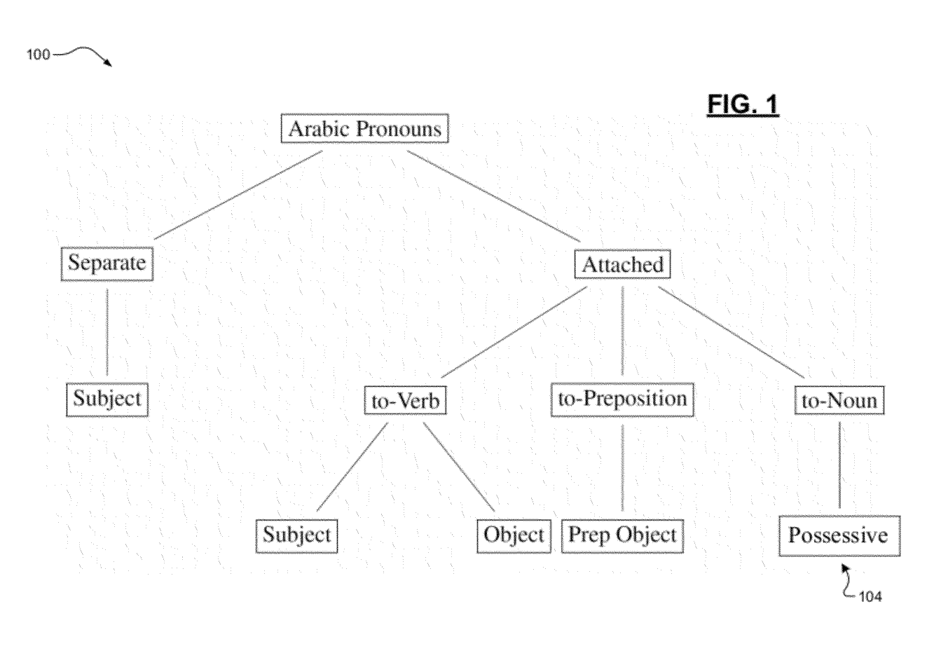

Personal pronouns in Arabic can be separate or attached. Similar to English, there are subject pronouns and object pronouns. In addition to the singular and plural pronouns, Arabic has also dual pronouns. Personal pronouns can attach to the end of verbs (subject or object) and to the end of prepositions. FIG. 1 shows a diagram of the Arabic pronouns. It shows that pronouns are divided into separate and attached. Separate pronouns are the subject pronouns. On the other hand, pronouns could be attached to verbs, prepositions or nouns. Pronouns attached to verbs are either subject or object pronouns. Pronouns can attach also to prepositions or nouns. All tree leaves represent personal pronouns except for the pronouns attached to nouns which are possessive pronouns. The leaf corresponding to possessive pronouns is highlighted. There are two reasons why personal pronouns should be penalized as separate phrases:
Subject pronouns are separate pronouns. They are uncommon because pronominal subjects can also be attached or dropped.
If a separate pronominal subject is generated in the target sentence, selecting a phrase containing the pronoun and verb together guarantee that they agree in gender, number, etc.

Possessive Pronouns

Referring now to FIG. 1, a tree 100 illustrating example relationships between various Arabic pronouns. As shown, a possessive pronoun 104 is always attached to the end of a noun. Example:

| | | |
|---|---|---|
| (5.1) | Her house | ( [symbol] ) |

| | |
|---|---|
| [symbol] | [symbol] |
| +ha | mnzl |

Because possessive pronouns in English are separate words, there are entries for them in the phrase table. These entries usually map to Arabic words with different meanings. Table B shows some phrase table entries to show what are they mapped to in Arabic. Sometimes, these phrases are selected by the decoder, which usually results in erroneous translations. Therefore, penalizing those phrases should prevent them from being selected.

TABLE B
Example of phrase table entries for possessive pronouns

| | | | | |
|---|---|---|---|---|
| her | [symbol] | [symbol] | [symbol] | [symbol] |
| | SAHbp | lhA | wqAlt | <n wqAlt |
| | owner | ‘for her’ | ‘and she said’ | ‘and she said that’ |
| His | [symbol] | [symbol] | [symbol] | [symbol] |
| | lp | tEryfp | tqryrp | bldp |
| | ‘for him’ | ‘his definition’ | ‘his report’ | ‘his country’ |

Prepositions and Particles

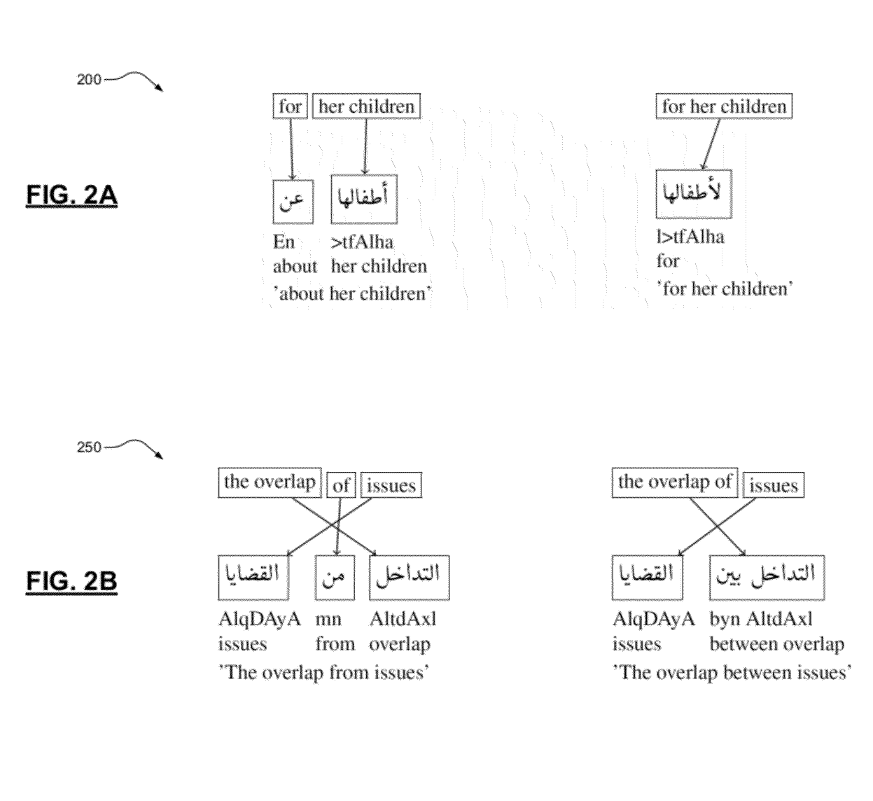

As shown in FIG. 1, there are attached and separate prepositions in Arabic. Prepositions were discussed above as an example of lexical divergences. Translating prepositions separately can be harmful because sometimes they should be attached to Arabic words and sometimes context is needed in order to select the correct preposition. FIG. 2A illustrates an example of an attached preposition, which was translated incorrectly. FIG. 2B also illustrates an example of separate prepositions, which were also translated incorrectly because they were translated as separate phrases.

Therefore, selecting phrases containing just prepositions should be avoided. By adding a feature to mark these phrases, the feature is expected to get a negative weight and therefore penalized compared to other available phrases.

Particles when translated separately usually result in additional Arabic words because phrasal verbs including the verb and preposition can map to an Arabic verb.

Determiners

The determiner class (DT) in English includes, in addition to other words, the definite and indefinite articles “the” and “a” or an”, respectively. In Arabic, the definite article corresponds to an “Al” attached as a prefix to the noun. There is no indefinite article in Arabic. Having them in separate phrases introduces noise. Table C shows their entries in the phrase table. As shown, they correspond to prepositions, which is very harmful to the adequacy and fluency of the output sentence.

TABLE C
Example of phrase table entries for determiners: a, the

| | | | | |
|---|---|---|---|---|
| a | [symbol] | [symbol] | [symbol] | [symbol] |
| | Ely | fy | mn | <ly |
| | on | in | from | to |
| the | [symbol] | [symbol] | [symbol] | [symbol] |
| | fy | Ely | mn | <ly |
| | in | on | from | to |

Wh-Nouns

Wh-nouns include wh-determiners, wh-pronouns, and possessive wh-pronouns having the POS tags WDT, WP, and WRB, respectively. Features for these POS tags can be added to discourage selecting separate phrases which are limited to wh-nouns. The motivation for this is mainly gender and number agreement. When they are attached in one phrase with the word they refer to, they would probably be translated in the correct form.

Dependency Features

These features are based on the syntactic dependency parse tree of the English source sentence. They mark the phrases which have the two words of a specific set of relations in the phrase. For example, a feature amod (adjective modifier) is added to a phrase which contains both the adjective and the noun. These features are expected to get positive weights when trained by MERT and thus make the decoder favor these phrases over others. The suggested dependency features are summarized in Table D. The relations' names follow the Stanford typed dependencies.

TABLE D
Dependency Relations Used as Features

| Relation | Explanation | Example |
|---|---|---|
| acomp | Adjectival Complement | She is beautiful r(is, beautiful) |
| amod | Adjectival Modifier | Same eats red meat:, r(meat, red) |
| aux | Auxiliary | Sam has died: r(died, has) |
| conj. | Conjunct | Same is nice and honest: |
| | | r(nice, honest) |
| det | Determiner | The wall is high: r(wall, the) |
| nsubj | Nominal Subject | Same left: r(left, Sam) |
| num | Numeric Modifier | I ate 3 apples: r(apples, 3) |
| ref | Referent | I saw the book which you bought: |
| | | r(book, which) |

The motivation behind these dependency features is mainly agreement: morphological or lexical. Assume that a₁ and a₂ are Arabic words that should have morphological agreement. Because phrases are extracted from the training data which are assumed to be morphologically correct, using a phrase that contains a₁ and a₂ assures that they agree.

As explained above, interesting morphological agreement relations include for example, noun-adjective and verb-subject relations. Lexical agreement relations include, for example, relations between phrasal verbs and their prepositions. For example, “talk about” is correct while “talk on” is not. Selecting a phrase where “talk” and its preposition “about” are attached guarantees their agreement.

Some of the dependency features are also motivated by the alignment problems discussed above. These problems arise from trying to align English sentences containing words that have no corresponding separate Arabic words in the Arabic sentences. For example, the acomp relation should favor selecting the phrase “is beautiful” over selecting the two separate phrase “is” and “beautiful”. This is because the phrase “is” would translate to an incorrect Arabic word. Also, aux is motivated by the same reason, because most auxiliaries have no corresponding words in Arabic.

Relations amod, nsubj, num, ref and conj are all motivated by inflectional agreement. The relation nsubj is also specifically useful if the subject is a pronoun, in which case it will be most of the time omitted in the Arabic and help in generating the correct verb inflection.

Adding det is beneficial in two ways. First, to discourage selecting a phrase with a separate “the” which would result in a wrong Arabic translation as shown in Table C. Second, attaching the determiner to its noun causes the Arabic word to have the correct form whether to have “Al” or not if the determiner in English is “the” or “a”, respectively.

Fixing Inflectional Agreement through Post-Processing

In this portion of the specification, a post-processing framework is described. The goal of this system is to fix inflectional agreement between syntactically related words in machine translation output.

### System Description

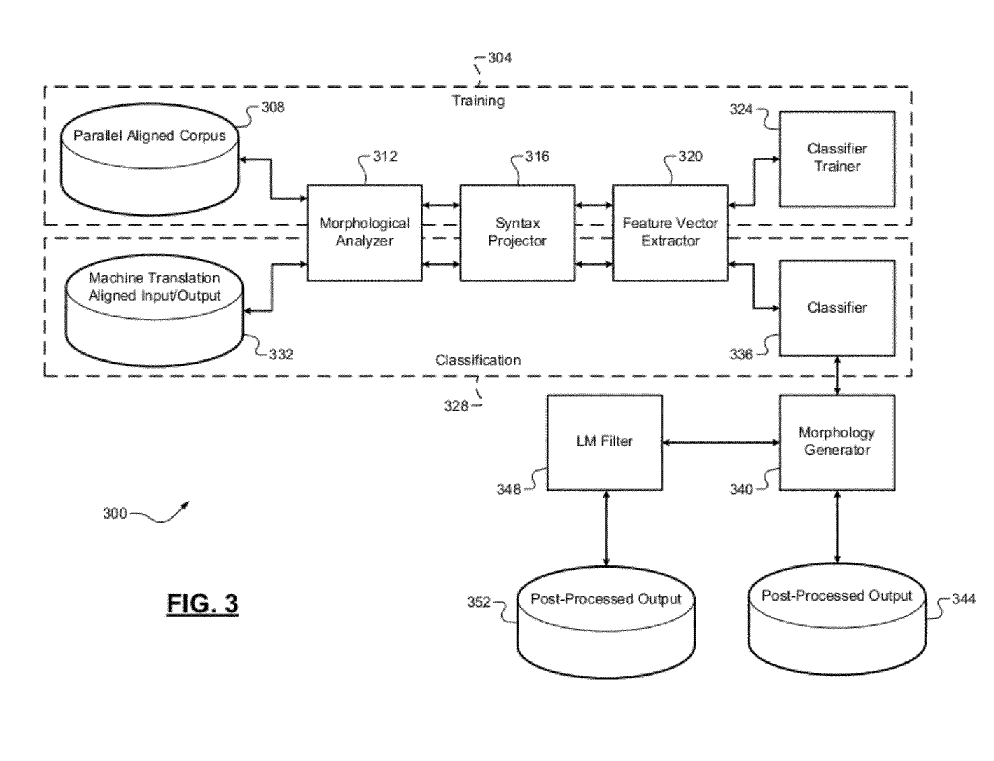

The post-processor is based on a learning framework. Given a training corpus of aligned sentence pairs, the system is trained to predict inflections of words in MT output sentences. The system uses a number of multi-class classifiers, one for each feature. For example, there is a separate classifier for gender and a separate classifier for number. FIG. 3 illustrates an example of the system pipeline 300. The system 300 and the techniques of the present disclosure can be implemented by one or more computing devices, each including one or more processors. The computing device(s) can operate in a parallel or distributed architecture, and the processor(s) of a specific computing device can also operate in a parallel or distributed architecture.

Referring now to FIG. 3, in the training phase 304, a reference aligned parallel corpus 308 is used. A morphology analyzer 312 analyzes the Arabic sentences. It specifies the lemma, the part-of-speech (POS) tag and the morphological features (e.g., gender, number, person) for every word in the sentence. A syntax projector 316 projects the dependency relations from the English sentence to the Arabic sentence using the alignments and the POS tags of both sentences. Subsequently, it extracts the agreement relations using the projected syntax. A feature vector extractor 320 is responsible for extracting the feature vectors out of the available lexical, morphological and syntactic information. The feature vectors as well as the correct labels which are extracted from the reference data are then used to train the classifiers by a classifier trainer 324.

For the prediction of the correct features, the MT translation output as well as the source sentence and the alignments are required. This can be referred to as a classification phase 328. Data from a machine translation aligned input/output datastore 332 goes through the same steps as in the training phase 304. The extracted feature vectors are then used to make predictions for each feature separately using a classifier 336.

After prediction/classification by the classifier 336, the correct features are then used along with the lemmas of the words to generate the correct inflected word by a morphology generator 340. Output of the morphology generator 340 can be stored in a first post-processed output datastore 344. Finally, an LM filter 348 uses an N-gram language model to add some robustness to the system 300 against the errors of alignment, morphology analysis and generation and classification. Output of the LM filter 348 can be stored in a second post-processed output datastore 352. If the generated sentence has a lower LM score than the baseline sentence, the baseline sentence is not updated.

### Algorithms for Inflection Prediction

As mentioned above, a system that can predict the correct inflections of specific words, e.g., words whose inflection is governed by agreement relations is described. A number of separate multi-class classifiers are trained, one for each morphological feature.

### Manual Rules

One way certain parts of a sentence should be inflected in correspondence to the inflection of other parts, e.g., the inflection of a verb based on its subject inflection or the inflection of an adjective based on the noun can be encoded in a finite set of rules. However, such rules can be very difficult to enumerate. The rules could differ from a “part of speech” to another and from one language to another. The difficulty of writing manual rules also arises from the existence of exceptional cases to all rules. Therefore, taking this approach both requires writing all set of POS and language dependent rules and also requires handling all the special cases.

For example, consider the inflection of an adjective in agreement with the modified noun.

The general rule: an adjective should follow the noun in gender, number, case and state.

### Some Exceptions:

If the noun is a broken plural representing objects (no persons), the adjective should be feminine and singular no matter what the gender of the noun is.
If the noun is a broken plural representing persons (masculine), the adjective could be in a broken plural or a regular plural form.
If the noun is a feminine plural representing objects, the adjective can be and is preferred to be singular.
   Therefore, a learning approach which could be easily extended to different agreement relations and different languages is preferable.

### Probabilistic Models

If all the dimensions affecting the correct word inflection could be encoded in a feature vector, many state-of-the-art probabilistic approaches can be used to predict the correct inflections. For example, a structured probabilistic model based on sentence order decomposition can be used. This system can have limitations in modeling agreement because their probabilistic model does not use the dependencies effectively. Although the prediction of a word inflection strongly depend on the inflection of the parent of the agreement relation, the feature vector in their system is composed of the stem of the parent.

A tree-based structured probabilistic model such as k-MEMM or CRF that use the dependency tree is theoretically very effective. However, dependency trees for Arabic sentences may be of poor quality and would result in a very noisy model that might degrade the MT output quality.

Predicting the inflection of each word according to its agreement relation separately can be very effective. As will be explained below, the relations are independent, for example, fixing the inflection of the adjective in an adjective-noun agreement relation is independent from fixing the inflection of the verb in a verb-subject agreement. Therefore, separating prediction adds robustness to the system and allows training with smaller corpora.

### Arabic Analysis and Generation

For Arabic analysis, the Morphological Analysis and Disambiguation for Arabic (MADA) system can be used. The system is built on the Buckwalter analyzer which generates multiple analyses for every word. MADA uses another analyzer and generator tool ALMORGEANA to convert the output of Buckwalter from a stem-affix format to a lexeme-and-feature format.

Afterwards, it uses an implementation of support vector machines which includes Viterbi encoding to disambiguate the results of AL-MORGEANA analyses. The result is a list of morphological features of every word taking the context (neighboring words in the sentence) into consideration. The morphological features that are evaluated by MADA are illustrated in Table E. The last four rows of the table represent the attachable clitics whose positions in the word are governed by [prc3 [prc2 [prc1 [pro0 BASEWORD enc0]]]]. For more details about those clitics and their functions, the user is referred to the MADA+TOKAN Manual. In addition to the features listed in the table, the analysis output includes the diacriticized form (diac), the lexeme/lemma (lex), the Buckwalter tag .(bw) and the English gloss (gloss).

For generation, the lexeme, POS tag and all other known features from Table E are input to the MORGEANA tool. The system searches in the lexicon for the word which has the most similar analysis.

The analysis and generation tools can be used to change the declension of a word. For example, to change a word w from the feminine to the masculine form, the following steps are taken:
Input to MADA the surface form of the word w. MADA will output the best lexeme l and list of features f for this word.
Change the gender feature in f from f(eminine) to m(asculine): f[gen]=m. The modified feature list can be referred to as f̅.
Input to the MORGEANA generator the lexeme l and the modified feature list f. MORGEANA will generate the word w̅ which is the masculine surface form of w.

TABLE E
Morphological Features resulting from MADA analysis

| Label | Name | Possible Values |
|---|---|---|
| pos | Part of | verb, noun, (adj)ective, prep(osition), part(icle) and |
| | speech | others, (total: 34) |
| asp | Aspect | c(ommand), i(mperfective), p(erfective), na(not |
| | | applicable) |
| cas | Case | n(ominative), a(ccusative), g(entitive), u(ndefined), na |
| gen | Gender | f(eminine), m(asculine), na |
| mod | Mood | i(ndicative), p(lural), d(ual), u(ndefined), na |
| num | Number | s(ingular), p(lural), (d(ual), u(ndefined), na |
| per | Person | 1, 2, 3, na |
| stt | State | i(ndefinite), d(efinite), c(construct/possessive/idafa), |
| | | u(ndefined), na |
| vox | Voice | A(ctive), p(assive), u(ndefined), na |
| prc0 | Proclitic | 0, na, >a_ques (interrogative particle >a) |
| | level 0 | |
| prc1 | Proclitic | 0, na, fa, wa |
| | level 1 | |
| prc2 | Proclitic | bi ka, la, li, sa, ta, wa, fi, lA, mA, yA, wA, hA |
| | level 2 | |
| enc0 | Enclitic | 0, na, pronouns, possessive pronouns and other |
| | | particles |

### Syntax Projection and Relation Extraction

To extract the morphologically dependent pairs (agreement pairs), syntax relations are needed. Although Arabic dependency tree parsers exist, for example the Berkeley and Stanford parsers, they can have poor quality. Parallel aligned data can instead be used to project the syntax tree from English to Arabic. The English parse tree is a labeled dependency tree following the grammatical representations described above. Two approaches to projection can be considered.

### Direct Projection

Given a source sentence consisting of a set of tokens sᵢ . . . sₙ, a dependency relation is a function hₛ such that for any sᵢ, hₛ(i) is the head of sᵢ and lₛ(i) is the label of the relation between sᵢ and hₛ(i).

Given an aligned target sentence tⱼ . . . tₘ, A is a set of pairs (sᵢ, tⱼ) such that sᵢ is aligned to tⱼ. Similarly, hₜ(j) is the head of tⱼ and lₜ(j) is the label of the relation between tⱼ and hₗ(j). Similar to the unlabeled tree projection, projection can be performed according to the following rule:

hᵢ(i)=j [symbol] ∃(sₘ,tᵢ),(sₙ,tⱼ)εA such that hₛ(m)=n (7)

Labels can be also projected using:

lᵢ(i)=x [symbol] ∃(sₘ,tᵢ),(sₙ,tⱼ)εA such that lₛ(m)=x (8)

Although this approach is helpful for identifying some Arabic dependency relations, it has a number of limitations.
Errors in the English parse tree are also projected to the Arabic parse tree.
Many-to-many alignments introduce ambiguities that are difficult to resolve.
The algorithm projects a dependency link as long as two pairs of words are aligned. Therefore, alignment errors result in projection errors. Also, the algorithm does not take into consideration the difference in structure between the two languages. For example, an Arabic noun might align to an English verb. In this case, the Arabic sentence can has a relation of “nsubj” with a noun head.

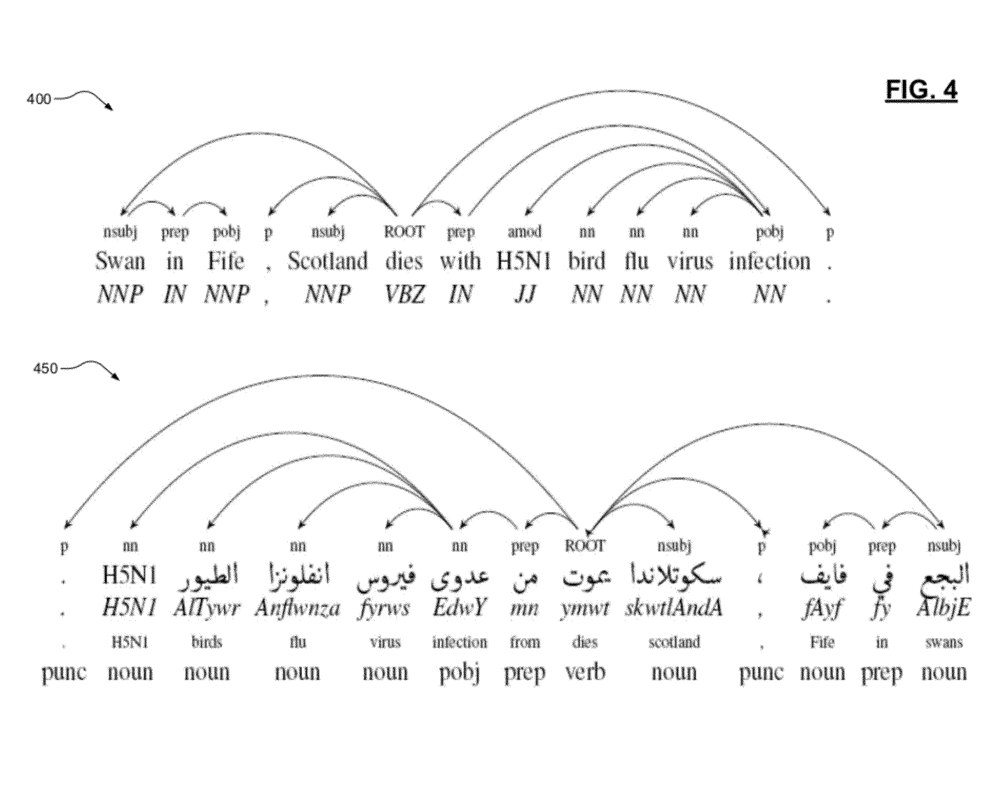

Referring now to FIG. 4, an example of the direct projection approach is illustrated. In this example, the alignment between source and target sentences is one-to-one, therefore, there is no ambiguity problem. An English parse tree is illustrated at 400 for the following example sentence: “Swan in Fife, Scotland dies with H5N1 bird flu virus infection.” However, as can be seen, errors by the English parser 400 were projected to an Arabic parse tree 450. More specifically, the resulting translation after projection to the Arabic parse tree 450 was the following incorrect translation: “H5N1 birds flu virus infection from dies Scotland, Fife in swans.”

Because of the above limitations, a different approach to partial tree projection can be used. This approach makes use of the Arabic analysis for robustness. It also takes syntactic divergences between the two languages into account.

### Approach

One goal of the dependency tree projection is the extraction of dependencies between pairs of words that should have morphological agreement, e.g., agreement links. Therefore, there is no need to first project the English tree to an Arabic tree from which agreement links can be extracted, which could introduce more errors. Therefore, extract agreement links can be extracted directly using the lexical and syntactic information of both the English and Arabic sentences taking into consideration the typological differences between the two languages. The projection of some of the interesting relations is explained below.

Adjective Relation (amod)

For an amod relation, an Arabic agreement relation is extracted if the English adjective aligns to an Arabic adjective, while the English noun aligns to an Arabic noun.

In the case when the English word aligns to multiple Arabic words, selecting the noun for the amod relation is based on the heuristic that the first noun after a preposition is marked as the noun of the relation. The motivation behind this rule is illustrated by example XV. If the first word of the multiple word alignment was selected as the noun of the relation, a link amod(AlfwtwgrAfy, mwad) would be extracted although amod(AlfwtogrAfy, IltSwyr) is the correct link. Therefore, linguistic analysis of erroneous agreement links lead to the mentioned rule.

| | |
|---|---|
| (XV) | Photographic chemicals |

| | |
|---|---|
| [symbol] | [symbol] |
| AlfwtwgrAfy | lltSwyr kymAwyp mwAd |
| Photographic | to-capturing chemical substances |

‘Chemical substances for photographic capturing’

Example XVI illustrates the ambiguity problem in a case of one-to-many alignment from English to Arabic. The word airline aligns to two Arabic words. The first word can be selected as the word being described by the adjective. However, in some cases, this rule introduces error.

| | |
|---|---|
| (XVI) | Saudi airlines |

| | |
|---|---|
| [symbol] | [symbol] |
| AlsEwdyp | AlTyrAn $rkAt |
| Saudi | Flight companies |

### Predicate-Subject Relation

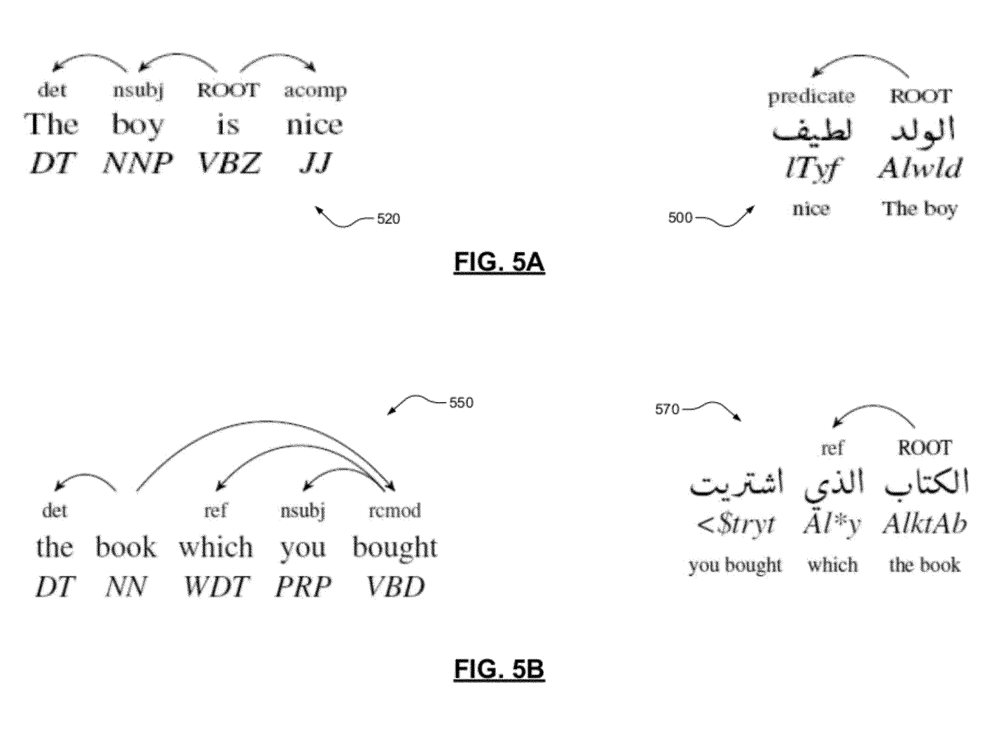

In an Arabic verb-less sentence, the predicate follows the subject of the sentence. FIG. 5A illustrates how the predicate and the subject of a verb-less Arabic sentence 500 can be extracted from an English syntactic dependency parse tree 520 indirectly. Specifically, the predicate ITyf has an agreement relation with the subject of the sentence Alwld.

### Verb-Subject Relation

The agreement link of interest is the link from the verb to the subject, which is the reverse of the link in the English dependency parse tree.

Relative Words (ref)

One way to extract the noun to which a relative word refers is through the English dependency parse tree. FIG. 5B illustrates an example projection of the ref relation from an English dependency parse tree 550 to an Arabic sentence 570.

### Feature Vector Extraction

The feature vector extractor 320 as shown in the framework diagram in FIG. 3 follows the morphology analysis and syntax projection. The selected features are from many sources of information: lexical, morphological and syntactic. Table F summarizes the features used in the feature vectors used by the classifiers.

TABLE F
The features used by the classifiers

| | | |
|---|---|---|
| Arabic | Morphological | asp, cas, gen, mod, num, per, stt, vox, |
| Features | | prc0 |
| | | prc1, prc2, enc0 (refer to table 6.1) |
| | | Feminine Ending: yes, no |
| | | Gloss Number: singular or plural |
| | | Plural Type: regular, irregular (broken |
| | | plurals) |
| | Syntactic | Part-of-speech (aligned, head) |
| | Lexical | Stem(head), English gloss(head) |
| English | Syntactic | part-of-speech (aligned, head) |
| Features | Lexical | surface form (aligned, head) |
| General | Relation Type | amod, verb, acomp, etc. |
| | Head position | before, after |

For Arabic Features, morphological features include the features returned by the morphology analyzer 312 of FIG. 3. In some implementations, an analysis of classification errors revealed regular errors caused by the morphology analyzer 312, for which two extra features were added: feminine ending and number of English gloss. Although all nouns and adjectives in Arabic that have particular endings, namely, “ [symbol] ”, “ [symbol] ”, and “ [symbol] ” are feminine, the morphology analyzer 312 confuses them frequently. The morphology analyzer 312 does not make use of these endings since it does not analyze the surface forms of the words; however, it uses prefix, suffix and stem lexicons to generate the features. Incorrect or missing labels to these words in the used lexicons would result in these errors.

The number of the English gloss is also added to overcome the persistent error of the analyzer to analyze broken plurals as singular. The reason is because it actually identifies a plural by whether the stem is attached to a clitic for plural marking. However, in the case of broken plurals, there is no affix added to the stem, however, it is derived from the singular form, a case of derivational morphology. As a solution to this problem, a feature is added to indicate whether any of the English glosses of the word is plural or not.

The feature “Plural Type” is added because it, significantly affects the decision about the correct inflection. For example, a regular masculine plural noun has its modifying adjective in masculine plural form, while an irregular plural noun usually has its modifying adjective in feminine singular form.

Syntactic features for Arabic include part of speech tags of the current and head words. Lexical features include the stem of the head word and the English gloss.

English features include the part of speech tags and the surface forms of the aligned and head words. On the other hand, general features include the dependency relation type and whether the head comes before or after the current word in the sentence. The latter feature is useful for example in the case of verbs where the verb inflection rules are different for the SVO order versus the VSO order.

### Training and Classification

In order to perform classifier training (see classifier trainer 324 of FIG. 3), the extracted feature vectors as well as the correct labels are needed. The data used for training is a set of parallel aligned sentences. The agreement relations are extracted as described above. For every relation pair, prediction is done for one word given the inflection of the parent and other bilingual and lexical information that are encoded in the feature vectors. The result of the morphological analyzer 312 for a specific feature is then used as the label for this feature classifier. Erroneous labels result in noisy training data and in imprecise classification accuracy evaluation.

For training the classifiers, an automatic tool can be used for selecting the best classification model for each feature and also for selecting the best parameters for this model using cross-validation. The reported accuracy is actually the mean accuracy of the folds of the cross validation.

In classification, after agreement relations and then feature vectors are extracted, prediction is done separately for each feature using the corresponding classifier.

### Language Model Incorporation

An N-Gram Language model is a probabilistic model specifically a model which predicts the next word in a sentence given the previous N words based on the Markov assumption. The N-Gram language model probability of a sentence is approximated as a multiplication of N-Gram probabilities as shown. in the second part of equation 9.

$$P ( {w}_{1} , … {w}_{m} ) = {\prod }_{i = 1}^{m} P ( {w}_{i} \vert {w}_{1} … {w}_{i - 1} ) \approx {\prod }_{i = 1}^{m} P ( {w}_{i} \vert {w}_{i - ( n - 1 )} … {w}_{i - 1} ) \qquad ( 9 )$$

The language model probability can be used as an indicator to the correctness and fluency of a modification. A comparison can be made between P(output sentence) and P(post-processed sentence). If the post-processed sentence has much less probability (e.g., less by a difference more than a certain threshold) than the output translation, changes to the sentence are canceled. Change filtering using a language model is expected to provide some robustness against all sources of errors in the system. However, the language model is not very reliable. A simple example would be that the generated inflected word is out of vocabulary (OOV) for the language model, although it is morphologically the correct one.

### Evaluation

To evaluate the system performance, accuracy of the classifiers is evaluated and compared to two other prediction algorithms. Prediction accuracy does not, however, measure the performance of the whole system. To evaluate the final output of the system, BLEU score is used. The BLEU score of the output is compared to BLEU score of the baseline MT system output. Because of the BLEU score limitations in evaluating morphological agreement, human evaluation is also used.

### BLEU

BLEU proved to be unreliable for evaluating morphological agreement because of the following:
In the evaluation data, every sentence has one reference human translation.
Because BLEU is based on merely counting which words (inflected surface forms) exist in the reference translations, two problems arise:
   There are cases where the updated words do not exist at all in the reference translation. The example in Table G shows a sentence whose agreement problem was fixed but this did not result in any change in BLEU score. Although the gender was corrected to be masculine in both words, this resulted in zero difference in BLEU score because the reference translation contained a synonym “AlmdAry” of the corrected word and not the word itself “Al<stwA′y”.
   There are cases where the original word inflection scored higher in BLEU score because the original word simply existed in the reference translation, although the agreement was wrong. The example in Table H shows how the SMT output sentence received a higher score than the post-processed one although the agreement was corrected and the whole sentence is grammatically and morphologically correct. The words in bold local governments can be noticed to disagree in definiteness in the translation output because local is definite and governments is indefinite. Although they were corrected to be both indefinite in the post-processed sentence, the post-processed sentence received a lower BLEU score. The reason is that the reference translation contains the definite form of the word governments and the word local. It is known that BLEU score is based on counting the words in the candidate translation whose surface forms exist in the reference translations. After correcting the agreement in post-processing, both the indefinite words local and governments were considered to be absent in the reference translation and thus BLEU score decreased.

TABLE G
Example about invalidity of BLEU

| Source | Tropical Weather | |
|---|---|---|
| Output | [symbol] | [symbol] |
| | AlmdAryp | AlTqs |
| | tropical.def.fem | weather.def.masc |
| Post | [symbol] | [symbol] |
| Processed | AlmdAry | AlTqs |
| | tropical.def.masc | weather.def.masc |
| Reference | [symbol] | [symbol] |
| | Al<stwA’y | AlTqs |
| | tropical.def.masc | weather.def.masc |

‘The Tropical Weather’

TABLE H
Example about invalidity of BLEU

| Source | Farms which are governed by local governments | | | | |
|---|---|---|---|---|---|
| Output | [symbol] | [symbol] | [symbol] | [symbol] | [symbol] |
| | Al.mHlyp | HkwmAt | tHkmhA | alty | AlmzArE. |
| | Local.def | governments.indef | govern it | which | farms. |
| Post | [symbol] | [symbol] | [symbol] | [symbol] | [symbol] |
| Processed | mHlyp | HkwmAt | tHkmhA | alty | AlmzArE. |
| | Local.indef | governments.indef | govern it | which | farms. |
| Reference | [symbol] | [symbol] | [symbol] | [symbol] | [symbol] |
| | Al.mHlyp | Al.HkwmAt | 1>dArp | AlxADEp | AlmzArE. |
| | Local.def | governments.def | the administration | that are under | farms |

‘Farms that are under the administration of the local governments’

### Human Evaluation

Side by side human evaluation is used for the evaluation of the techniques. The goal is to rate the translation quality. The human raters are provided with the source sentence and two Arabic sentence outputs, one is the output of baseline system and the other is the post-processed sentence. The sentences are shuffles; therefore, the raters score the sentences without knowing their sources. They give a rating between 0 and 6 according to meaning and grammar. 6 is the best rating for perfect meaning and grammar, while 0 is the lowest rating for cases when there is no meaning preserved and thus the grammar is irrelevant. Ratings from 5 to 3 are for sentences whose meaning is preserved but with increasing grammar mistakes. Ratings below 3 are for sentences that have no meaning, in which case the grammar becomes irrelevant and has minimal effect on the quality score.

Therefore, the human evaluation results are not expected to directly reflect whether the inflectional agreement, which is a grammatical feature, is fixed or not in the sentences. For sentences with high quality meaning, having the correct inflectional agreement should correspond to in-creasing the sentence score. However, sentences with no preserved meanings are not expected to receive higher scores for correct morphological agreement.

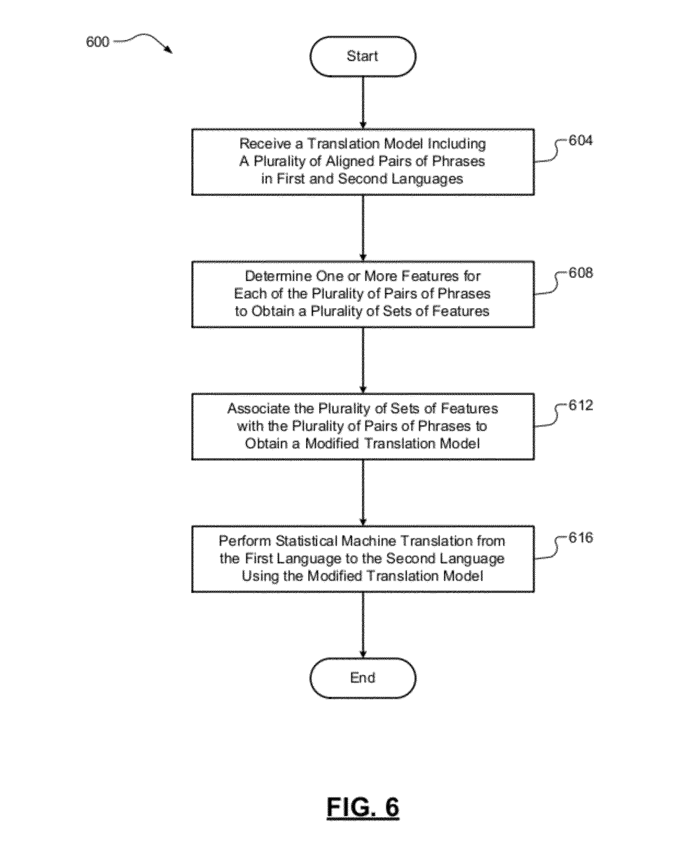

Referring now to FIG. 6, an example technique 600 for generating a modified translation model is illustrated. At 604, the technique 600 can receive, e.g., at a computing system including one or more processors, a translation model including a plurality of pairs of phrases. Each of the plurality of pairs of phrases can include a first phrase of one or more words in a first language and a second phrase of one or more words in a second language. A specific first phrase can be aligned with a specific second phrase for a specific pair of phrases. At 608, the technique 600 can determine, e.g., at the computing system, one or more features for each of the plurality of pairs of phrases based on linguistic differences between the first and second languages to obtain a plurality of sets of features. At 612, the technique 600 can associate, e.g., at the computing system, the plurality of sets of features with the plurality of pairs of phrases, respectively, to obtain a modified translation model. At 616, the technique 600 can, e.g., at the computing system, perform statistical machine translation from the first language to the second language using the modified translation model. The technique 600 can then end or return to 604 for one or more additional cycles.

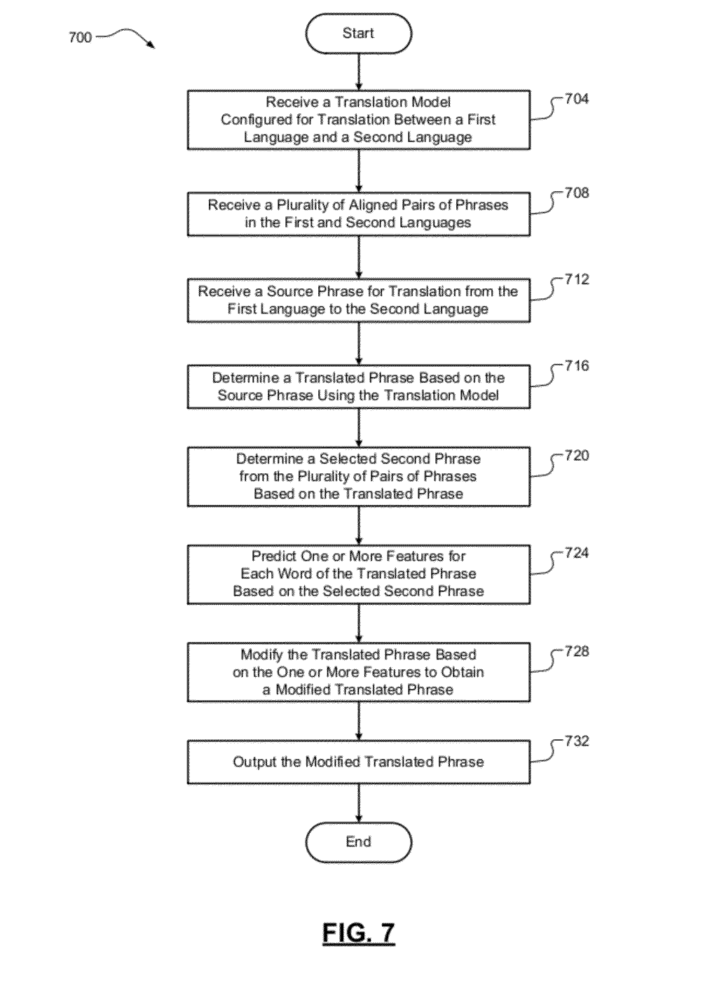

Referring now to FIG. 7, an example technique 700 for post-processing of a translated phrase is illustrated. At 704, the technique 700 can, e.g., at a computing system including one or more processors, receive a translation model configured for translation between a first language and a second language. At 704, the technique 700 can, e.g., at the computing system, receive a plurality of pairs of phrases. Each of the plurality of pairs of phrases can include a first phrase of one or more words in the first language and a second phrase of one or more words in the second language. A specific first phrase can be aligned with a specific second phrase for a specific pair of phrases. At 712, the technique 700 can, e.g., at the computing system, receive a source phrase for translation from the first language to the second language. At 716, the technique 700 can, e.g., at the computing system, determine a translated phrase based on the source phrase using the translation model. At 720, the technique 700 can, e.g., at the computing system, determine a selected second phrase from the plurality of pairs of phrases based on the translated phrase. At 724, the technique 700 can, e.g., at the computing system, predict one or more features for each word of the translated phrase based on the selected second phrase, a selected first phrase associated with the selected second phrase, and linguistic differences between the first and second languages. At 728, the technique 700 can, e.g., at the computing system, modify the translated phrase based on the one or more features to obtain a modified translated phrase. At 732, the technique 700 can, e.g., at the computing system, output the modified translated phrase. The technique 700 can then end or return to 704 for one or more additional cycles.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus, and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) Monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, at a computing system including one or more processors, a translation model including a plurality of pairs of phrases, each of the plurality of pairs of phrases including a first phrase of one or more words in a first language and a second phrase of one or more words in a second language, wherein a specific first phrase is aligned with a specific second phrase for a specific pair of phrases;
determining, at the computing system, one or more features for each of the plurality of pairs of phrases based on linguistic differences between the first and second languages to obtain a plurality of sets of features;
associating, at the computing system, the plurality of sets of features with the plurality of pairs of phrases, respectively, to obtain a modified translation model; and
performing, at the computing system, statistical machine translation from the first language to the second language using the modified translation model.

2. The computer-implemented method of claim 1, wherein the modified translation model has lexical and inflectional agreement for each of the plurality of pairs of phrases.

3. The computer-implemented method of claim 1, wherein one of the first and second languages is a morphologically-rich language.

4. The computer-implemented method of claim 3, wherein the morphologically-rich language is characterized by morphological processes that produce a large number of word forms for a given root word.

5. The computer-implemented method of claim 3, wherein the morphologically-rich language is a synthetic language.

6. The computer-implemented method of claim 3, wherein one of the first and second languages is a non-morphologically-rich language.

7. The computer-implemented method of claim 6, wherein the non-morphologically-rich language is an isolating language or an analytic language.

8. The computer-implemented method of claim 1, wherein the one or more features include at least one of parts of speech features and dependency features.

9. The computer-implemented method of claim 8, wherein the parts of speech features include at least one of personal pronouns, possessive pronouns, determiners, particles, and wh-nouns.

10. The computer-implemented method of claim 8, wherein the dependency features include syntactic divergences including at least one of word order, verb-less phrases, and possessiveness.

11. The computer-implemented method of claim 8, wherein the dependency features include lexical divergences including at least one of idiomatic expressions, prepositions, named entities, ambiguity, and alignment difficulties.

12. The computer-implemented method of claim 1, wherein performing the statistical machine translation using the modified translation model further includes:
receiving, at the computing system, one or more words in the first language;
generating, at the computing system, one or more potential translations of the one or more words using the modified translation model, the one or more potential translations having one or more probability scores, respectively;
selecting, at the computing system, one of the one or more potential translations based on the one or more probability scores to obtain a selected translation; and
outputting, at the computing system, the selected translation.

13. A computer-implemented method comprising:
receiving, at a computing system including one or more processors, a translation model configured for translation between a first language and a second language;
receiving, at the computing system, a plurality of pairs of phrases, each of the plurality of pairs of phrases including a first phrase of one or more words in the first language and a second phrase of one or more words in the second language, wherein a specific first phrase is aligned with a specific second phrase for a specific pair of phrases;
receiving, at the computing system, a source phrase for translation from the first language to the second language;
determining, at the computing system, a translated phrase based on the source phrase using the translation model;
determining, at the computing system, a selected second phrase from the plurality of pairs of phrases based on the translated phrase;
predicting, at the computing system, one or more features for each word of the translated phrase based on the selected second phrase, a selected first phrase associated with the selected second phrase, and linguistic differences between the first and second languages;
modifying, at the computing system, the translated phrase based on the one or more features to obtain a modified translated phrase; and
outputting, from the computing system, the modified translated phrase.

14. The computer-implemented method of claim 13, wherein the translated phrase has lexical and inflectional agreement with the source phrase.

15. The computer-implemented method of claim 13, wherein the one or more features include at least one of lemma, parts of speech features, morphological features, and dependency features.

16. The computer-implemented method of claim 15, wherein predicting the one or more features for each word in the translated phrase further includes determining, at the computing system, at least one of the lemma, the part of speech features, and the morphological features for each word in the selected first phrase and for each word in the selected second phrase.

17. The computer-implemented method of claim 16, wherein predicting the one or more features for each word in the translated phrase further includes projecting, at the computing system, dependency relations from the selected first phrase to the selected second phrase based on an alignment between the selected first phrase and the selected second phrase and the part of speech features of both the selected first phrase and the selected second phrase.

18. The computer-implemented method of claim 15, wherein the parts of speech features include at least one of personal pronouns, possessive pronouns, determiners, particles, and wh-nouns.

19. The computer-implemented method of claim 15, wherein the dependency features include syntactic divergences including at least one of word order, verb-less phrases, and possessiveness.

20. The computer-implemented method of claim 15, wherein the dependency features include lexical divergences including at least one of idiomatic expressions, prepositions, named entities, ambiguity, and alignment difficulties.

21. The computer-implemented method of claim 13, wherein one of the first and second languages is a morphologically-rich language.

22. The computer-implemented method of claim 21 wherein the morphologically-rich language is characterized by morphological processes that produce a large number of word forms for a given root word.

23. The computer-implemented method of claim 21, wherein the morphologically-rich language is a synthetic language.

24. The computer-implemented method of claim 21, wherein one of the first and second languages is a non-morphologically-rich language.

25. The computer-implemented method of claim 24, wherein the non-morphologically-rich language is an isolating language or an analytic language.

26. A system comprising:
one or more computing devices configured to perform operations including:
receiving a translation model including a plurality of pairs of phrases, each of the plurality of pairs of phrases including a first phrase of one or more words in a first language and a second phrase of one or more words in a second language, wherein a specific first phrase is aligned with a specific second phrase for a specific pair of phrases;
determining one or more features for each of the plurality of pairs of phrases based on linguistic differences between the first and second languages to obtain a plurality of sets of features;
associating the plurality of sets of features with the plurality of pairs of phrases, respectively, to obtain a modified translation model; and
performing statistical machine translation from the first language to the second language using the modified translation model.

27. The system of claim 26, wherein the modified translation model has lexical and inflectional agreement for each of the plurality of pairs of phrases.

28. The system of claim 26, wherein one of the first and second languages is a morphologically-rich language.

29. The system of claim 28, wherein the morphologically-rich language is characterized by morphological processes that produce a large number of word forms for a given root word.

30. The system of claim 28, wherein the morphologically-rich language is a synthetic language.

31. The system of claim 28, wherein one of the first and second languages is a non-morphologically-rich language.

32. The system of claim 31, wherein the non-morphologically-rich language is an isolating language or an analytic language.

33. The system of claim 26, wherein the one or more features include at least one of parts of speech features and dependency features.

34. The system of claim 33, wherein the parts of speech features include at least one of personal pronouns, possessive pronouns, determiners, particles, and wh-nouns.

35. The system of claim 33, wherein the dependency features include syntactic divergences including at least one of word order, verb-less phrases, and possessiveness.

36. The system of claim 33, wherein the dependency features include lexical divergences including at least one of idiomatic expressions, prepositions, named entities, ambiguity, and alignment difficulties.

37. The system of claim 26, wherein the operation of performing the statistical machine translation using the modified translation model further includes:
receiving one or more words in the first language;
generating one or more potential translations of the one or more words using the modified translation model, the one or more potential translations having one or more probability scores, respectively;
selecting one of the one or more potential translations based on the one or more probability scores to obtain a selected translation; and
outputting the selected translation.

38. A system comprising:
one or more computing devices configured to perform operations including:
receiving a translation model configured for translation between a first language and a second language;
receiving a plurality of pairs of phrases, each of the plurality of pairs of phrases including a first phrase of one or more words in the first language and a second phrase of one or more words in the second language, wherein a specific first phrase is aligned with a specific second phrase for a specific pair of phrases;
receiving a source phrase for translation from the first language to the second language;
determining a translated phrase based on the source phrase using the translation model;
determining a selected second phrase from the plurality of pairs of phrases based on the translated phrase;
predicting one or more features for each word of the translated phrase based on the selected second phrase, a selected first phrase associated with the selected second phrase, and linguistic differences between the first and second languages;
modifying the translated phrase based on the one or more features to obtain a modified translated phrase; and
outputting the modified translated phrase.

39. The system of claim 38, wherein the translated phrase has lexical and inflectional agreement with the source phrase.

40. The system of claim 38, wherein the one or more features include at least one of lemma, parts of speech features, morphological features, and dependency features.

41. The system of claim 40, wherein the operation of predicting the one or more features for each word in the translated phrase further includes determining at least one of the lemma, the part of speech features, and the morphological features for each word in the selected first phrase and for each word in the selected second phrase.

42. The system of claim 41, wherein the operation of predicting the one or more features for each word in the translated phrase further includes projecting dependency relations from the selected first phrase to the selected second phrase based on an alignment between the selected first phrase and the selected second phrase and the part of speech features of both the selected first phrase and the selected second phrase.

43. The system of claim 40, wherein the parts of speech features include at least one of personal pronouns, possessive pronouns, determiners, particles, and wh-nouns.

44. The system of claim 40, wherein the dependency features include syntactic divergences including at least one of word order, verb-less phrases, and possessiveness.

45. The system of claim 40, wherein the dependency features include lexical divergences including at least one of idiomatic expressions, prepositions, named entities, ambiguity, and alignment difficulties.

46. The system of claim 38, wherein one of the first and second languages is a morphologically-rich language.

47. The system of claim 46 wherein the morphologically-rich language is characterized by morphological processes that produce a large number of word forms for a given root word.

48. The system of claim 46, wherein the morphologically-rich language is a synthetic language.

49. The system of claim 46, wherein one of the first and second languages is a non-morphologically-rich language.

50. The system of claim 49, wherein the non-morphologically-rich language is an isolating language or an analytic language.
